(19) United States
(12) Patent Application Publication
(10) Pub. No.: US 2025/0037525 A1
(43) Pub. Date: Jan. 30, 2025

(54) ENABLING A VISITOR ACCESS IN A BUILDING

(71) Applicant: KONE Corporation, Helsinki (FI)

(72) Inventors: Jouni JUNES, Helsinki (FI); Aapo SAARI, Helsinki (FI); Jussi LAURILA, Helsinki (FI); Visa RAUTA, Helsinki (FI)

(73) Assignee: KONE Corporation, Helsinki (FI)

(21) Appl. No.: 18/913,575

(22) Filed: Oct. 11, 2024

Related U.S. Application Data
(63) Continuation of application No. PCT/FI2022/050251, filed on Apr. 14, 2022.

(51) Int. Cl. G07C 9/20; G06K 7/14

(52) U.S. Cl. CPC G07C 9/20; G06K 7/1417

(57) ABSTRACT

According to an aspect, there is provided a solution for enabling a visitor access in a building. An apparatus may be configured to a request to generate a visual token reading invitation for a visitor of a building, the visual token reading invitation being associated with a visual token. The apparatus may be configured to generate the visual token reading invitation in response to the request. The apparatus may be configured to obtain an indication of a reading action of the visual token provided at a location of the building. The apparatus may be configured to enable at least one access right in the building in response to obtaining the indication of the reading action of the visual token.

### TECHNICAL FIELD

The present application relates to the field of building access systems. More particularly, the present application relates to enabling a visitor access in a building.

### BACKGROUND

There may be different kinds of access solutions used in different building types. For example, in an office building, employees may use access cards or radio frequency transmission based solutions in order to gain access to various premises or elevators. These solutions work well in cases where a user permanently lives or works in the building.

However, in cases when, for example, a visitor comes to visit a building, a challenge is that the visitor does not have permanent access rights in the building. In some cases, there may be a reception or an info desk at a lobby of the building in order to obtain, for example, a temporary visiting badge with some access rights. These desks, however, do not exist in every building. In another example, a tenant or an owner living in a building may have access codes, for example, to doors or elevators, but the tenant or owner cannot or may not be willing to give this information to a visitor visiting the building.

### SUMMARY

According to a first aspect, there is provided a method that comprises obtaining, by an apparatus, a request to generate a visual token reading invitation for a visitor of a building, the visual token reading invitation being associated with a visual token; generating, by the apparatus, the visual token reading invitation in response to the request; obtaining, by the apparatus, an indication of a reading action of the visual token provided at a location of the building; and enabling, by the apparatus, at least one access right in the building in response to obtaining the indication of the reading action of the visual token.

In an implementation form, the method further comprises associating, by the apparatus, a visitor identifier with the visual token reading invitation.

In an implementation form, the method further comprises obtaining, by the apparatus, a visitor identifier; comparing, by the apparatus, the obtained visitor identifier with the visitor identifier associated with the visual token reading invitation for; and enabling, by the apparatus, the at least one access right in the building in response to a positive comparison result.

In an implementation form, the method further comprises in response to obtaining the indication of the reading action of the visual token, causing, by the apparatus, transmission of a request to a node to provide a visitor identifier; receiving, by the apparatus, the visitor identifier from the node; comparing, by the apparatus, the received visitor identifier with the visitor identifier associated with the visual token reading invitation; and enabling, by the apparatus, the at least one access right in response to a successful comparison result.

In an implementation form, the visitor identifier comprises at least one of a phone number, a code, a one-time code, identification information or user registration information associated with an application.

In an implementation form, the method further comprises associating, by the apparatus, a validity time for the visual token reading invitation; in response to obtaining the visual token reading indication of the reading action of the visual token, checking, by the apparatus, the validity of the invitation based on the validity time; and enabling, by the apparatus, the at least one access right when the invitation is valid.

In an implementation form, the method further comprises causing, by the apparatus, transmission of at least one request to an external apparatus to apply the at least one access right.

In an implementation form, the method further comprises associating, by the apparatus, at least one of an elevator call to be made, guidance information or access information with the visual token reading invitation.

In an implementation form, the method further comprises causing, by the apparatus, transmission of the visual token reading invitation.

In an implementation form, the visual token reading invitation is a unique visual token reading invitation.

In an implementation form, the visual token is unique to the visitor.

In an implementation form, the method further comprises causing, the by apparatus, transmission of an instruction to display guidance information with a node to reach a predetermined destination in the building in response to enabling the at least one access right.

In an implementation form, the method further comprises causing, by the apparatus, an instruction to display the visual token with a system node in response to obtaining an indication of an opening action of the visual token reading invitation.

In an implementation form, enabling, by the apparatus, at least one access right in the building in response to obtaining the indication, comprises allocating, by the apparatus, an elevator call.

In an implementation form, enabling, by the apparatus, at least one access right in response to obtaining the indication, comprises opening, by the apparatus, an access point.

In an implementation form, enabling, by the apparatus, at least one access right in response to obtaining the indication, comprises obtaining, by the apparatus, an indication of at least one additional reading action of the visual token provided at a location of the building; and removing, by the apparatus, the at least one access right in response to obtaining the indication of at least one additional reading action of the visual token.

In an implementation form, the visual token comprises a two-dimensional code, a bar code, a QR code, text, an animation, a number sequence or an alphanumeric sequence.

In an implementation form, the apparatus comprises an elevator controller or an elevator group controller.

According to a second aspect, there is provided an apparatus comprising means for obtaining a request to generate a visual token reading invitation for a visitor of a building, the visual token reading invitation being associated with a visual token; means for generating the visual token reading invitation in response to the request; means for obtaining an indication of a reading action of the visual token provided at a location of the building; and means for enabling at least one access right in the building in response to obtaining the indication of the reading action of the visual token.

In an implementation form, the apparatus comprises means for associating a visitor identifier with the visual token reading invitation.

In an implementation form, the apparatus comprises means for obtaining a visitor identifier; means for comparing the obtained visitor identifier with the visitor identifier associated with the visual token reading invitation for; and means for enabling the at least one 15 access right in the building in response to a positive comparison result.

In an implementation form, the apparatus comprises means for causing transmission of a request to a node to provide a visitor identifier in response to obtaining the indication of the reading action of the visual token; means for receiving the visitor identifier from the node; means for comparing the received visitor identifier with the visitor identifier associated with the visual token reading invitation; and means for enabling the at least one access right in response to a successful comparison result.

In an implementation form, the visitor identifier comprises at least one of a phone number, a code, a one-time code or user registration information associated with an application.

In an implementation form, the apparatus comprises means for associating a validity time for the visual token reading invitation; means for checking the validity of the visual token reading token based on the validity time in response to obtaining the indication of the reading action of the visual token; and means for enabling the at least one access right when the invitation is valid.

In an implementation form, the apparatus comprises means for causing transmission of at least one request to an external apparatus to apply the at least one access right.

In an implementation form, the apparatus comprises means for associating at least one of an elevator call to be made, guidance information or access information with the visual token reading invitation.

In an implementation form, the apparatus comprises means for causing transmission of the visual token reading invitation.

In an implementation form, the visual token reading invitation is a unique visual token reading invitation.

In an implementation form, the apparatus comprises the visual token is unique to the visitor.

In an implementation form, the apparatus comprises means for causing transmission of an instruction to display guidance information with a node to reach a predetermined destination in the building in response to enabling the at least one access right.

In an implementation form, the apparatus comprises means for causing an instruction to display the visual token with a system node in response to obtaining an indication of an opening action of the visual token reading invitation.

In an implementation form, the means for enabling are configured to allocate an elevator call.

In an implementation form, the means for enabling are configured to open an access point.

In an implementation form, the means for enabling are configured to obtain an indication of at least one additional reading action of the visual token provided at a location of the building, and remove the at least one access right in response to obtaining the indication of at least one additional reading action of the visual token.

In an implementation form, the visual token comprises a two-dimensional code, a bar code, a QR code, text, an animation, a number sequence or an alphanumeric sequence.

In an implementation form, the apparatus comprises an elevator controller or an elevator group controller.

According to a third aspect, there is provided a system comprising the apparatus of the second aspect and at least one node configured to display the visual token.

In an implementation form, the system comprises an elevator system comprising at least one elevator.

According to a fourth aspect, there is provided an apparatus comprising at least one processor and at least one memory including computer program code. The at least one memory and the computer program code are configured to, with the at least one processor, cause the apparatus at least to: obtain a request to generate a visual token reading invitation for a visitor of a building, the visual token reading invitation being associated with a visual token; generate the visual token reading invitation in response to the request; obtain an indication of a reading action of the visual token provided at a location of the building; and enable at least one access right in the building in response to obtaining the indication of the reading action of the visual token.

According to a fifth aspect, there is provided a computer program comprising instructions for causing an apparatus to perform at least the following: obtaining a request to generate a visual token reading invitation for a visitor of a building, the visual token reading invitation being associated with a visual token; generating the visual token reading invitation in response to the request; obtaining an indication of a reading action of the visual token provided at a location of the building; and enabling at least one access right in the building in response to obtaining the indication of the reading action of the visual token.

According to a sixth aspect, there is provided a computer-readable medium comprising a computer program comprising instructions for causing an apparatus to perform at least the following: obtaining a request to generate a visual token reading invitation for a visitor of a building, the visual token reading invitation being associated with a visual token; generating the visual token reading invitation in response to the request; obtaining an indication of a reading action of the visual token provided at a location of the building; and enabling at least one access right in the building in response to obtaining the indication of the reading action of the visual token.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a method according to an example embodiment.

FIG. 2 illustrates a method according to another example embodiment.

FIG. 3 illustrates an apparatus according to an example embodiment.

FIG. 4 illustrates a system according to an example embodiment.

FIG. 5 illustrates a system according to another example embodiment.

### DETAILED DESCRIPTION

The following description illustrates a solution for enabling a visitor access in a building. The illustrated solution may enable, for example, a solution in which there is no need to issue any physical access cards or key fobs to the visitor while still providing an access to the visitor.

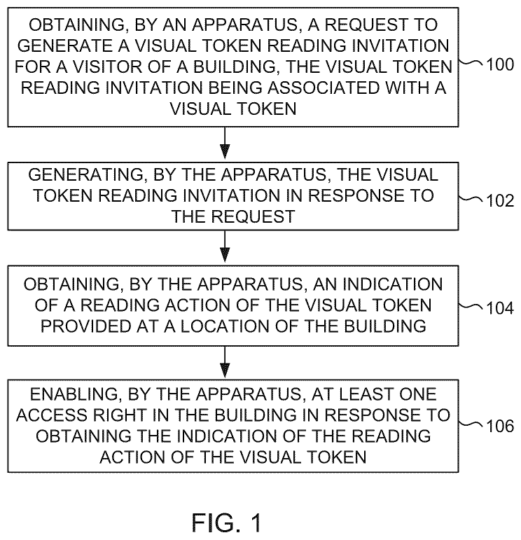

FIG. 1 illustrates a method according to an example embodiment.

At step 100 an apparatus may obtain a request to generate a visual token reading invitation for a visitor of a building, the visual token reading invitation being associated with a visual token. The apparatus may be, for example, an apparatus in building management system, in a visitor access system or an elevator system apparatus. The visual token may refer to any visual token that may be read using a reader, for example, a camera. The visual token may comprise, for example, a bar code, a QR code, text, an animation, a number sequence, an alphanumeric sequence etc. Further, the visual token may be unique among other visual tokens or the same visual token may be used in at least two different locations. The request may be obtained, for example, from a tenant or an employee of a building using, for example, a web based interface or a mobile application executed by a mobile device of the tenant or employee, when the tenant or employee adds a new visitor to a visitor list. When the is made, the apparatus may associate, at least one of an elevator call to be made, guidance information or access information with the visual token reading invitation.

At step 102 the apparatus may generate the visual token reading invitation in response to the request. The invitation may be, for example, a website link, a QR code reader website link, an invitation triggering opening of a reader application, an activation of a reader application, or an authorization of a reader application. In an example embodiment, the generated invitation may be automatically sent to the visitor, for example, via email, a short message using a mobile communication network, if an email address or a phone number is provided to the visitor, instant messaging, or messaging associated with an application installed in a mobile device of the visitor. In an example embodiment, the visual token reading invitation may be valid for a certain time period, and/or it may be individual, i.e. unique for a certain visitor.

At step 104 an indication of a reading action of the visual token provided at a location of the building may be obtained by the apparatus. The location may be associated with an access point, for example, a door, an elevator car or another access point in which some identification may be needed for the access. For example, the visitor may select the received invitation, which results in opening, for example, a QR code reader on a browser in the visitor's smart phone. The visitor may then scan the QR code with the QR code reader. In another example embodiment, the visual token may be read using an application stored in the visitor's smart phone or other mobile device. The application may refer, for example, to a commonly available QR code reader application, or to an application associated with the manufacturer of the elevator system. This causes the indication to be sent to the apparatus, and the apparatus may recognize that the visual token has been scanned through the correct invitation.

In an example embodiment, the apparatus may be configured to obtain or request positioning data from the visitor's smart phone. The positioning data may refer, for example, to satellite positioning data or indoor positioning data. Based on the positioning data, the apparatus may be configured to check or verify that the smart phone was or has been at the location or in proximity of the location. This may provide an additional verification about the validity of the indication or the reading action.

At step 106, the apparatus may enable at least one access right in the building in response to obtaining the indication of the reading action of the visual token. If the apparatus has direct control over one or more nodes or entities in the building, the apparatus itself may grant access to a node or other entity. In another example embodiment, the apparatus may not have a direct control over the one or more nodes or entities in the building, and the apparatus may send a control request to another controlling entity in the building. For example, an elevator call may have earlier been associated with the visual token reading invitation. When the access right is enabled, the apparatus may automatically transmit a request to an elevator system in the building to allocate an elevator for the elevator call.

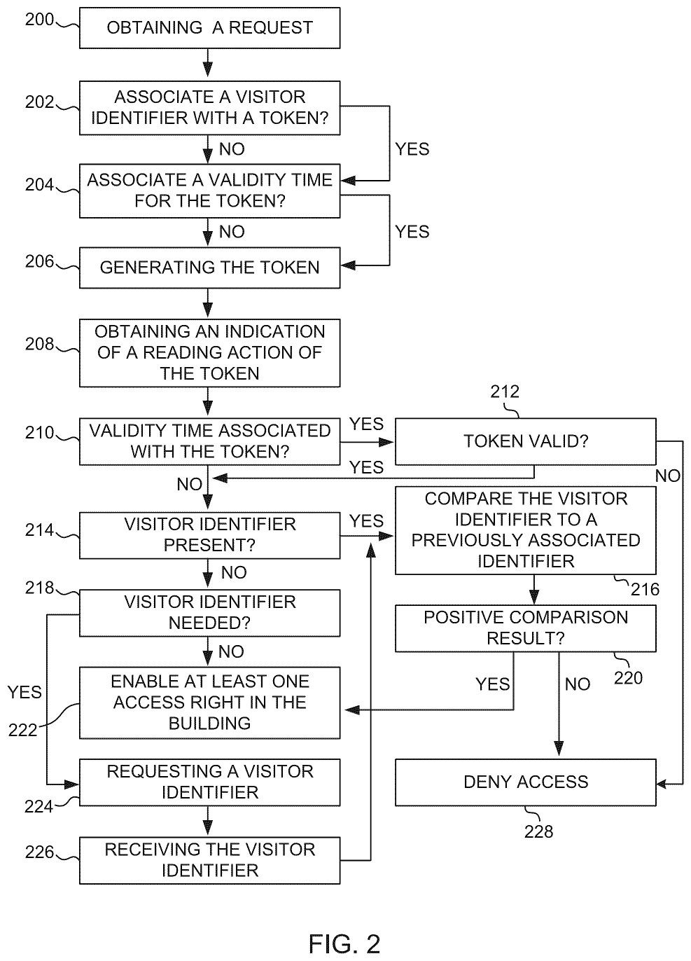

FIG. 2 illustrates a method according to another example embodiment.

At step 200 an apparatus may obtain a request to generate a visual token reading invitation for a visitor of a building, the visual token reading invitation being associated with a visual token. The apparatus may be, for example, an apparatus in building management system, in a visitor access system or an elevator system controller. The visual token may refer to any code that may be read using a reader, for example, a camera. The visual token may comprise, for example, a bar code, a QR code, text, an animation, a number sequence, an alphanumeric sequence etc. Further, the visual token may be unique among other visual tokens or the same visual token may be used in at least two different locations. The request may be obtained, for example, from a tenant or employee of a building using, for example, a web based interface or a mobile application executed by a mobile device of the tenant or employee, when the tenant or employee adds a new visitor to a visitor list. The apparatus may associate at least one of an elevator call to be made, guidance information or access information with the visual token reading invitation.

At step 202 it may be determined whether a visitor identifier is to be associated with the visual token reading invitation. The visitor identifier may be used to identify the visitor. The visitor identifier may comprise, for example, at least one of a phone number, a code, a one-time code, identification information or user registration information associated with an application. The application may be, for example, an application executed in a visitor's mobile device, and the visitor may have a registered identity in the application. This identity may then be used for identifying the visitor.

At step 204 it may be determined whether a validity condition or validity time is to be associated with the visual token reading invitation. In an example embodiment, the visual token reading invitation may be set to be valid only for a certain time period. The time period may be expressed, for example, in days, hours and/or minutes. For example, the visual token reading invitation may be valid only on weekdays between 06:00-08:00 or only on a certain day between 13:00-13:10. In another example embodiment, the validity condition or validity time may refer, for example, to the number of times that the visual token reading invitation can be used.

At step 206 the apparatus may generate the visual token reading invitation in response to the request. The link may be, for example, a website link or a QR code reader website link. In an example embodiment, the generated invitation may be automatically sent to the visitor, for example, via an email or a short message using a mobile communication network, if an email address or a phone number is provided to the visitor, or via instant messaging or application-specific messaging. In an example embodiment, the visual token may be individual, i.e. unique for a certain visitor or a common for a plurality of visitors.

At step 208 an indication of a reading action of the visual token provided at a location of the building may be obtained by the apparatus. For example, the visitor may select the received invitation, which results in opening, for example, a QR code reader on a browser in the visitor's smart phone. The visitor may then scan the QR code with the QR code reader. This causes the indication to be sent to the apparatus, and the apparatus may recognize that the QR code has been scanned through the correct invitation.

At 210 it may be determined whether a validity condition or a validity time has been associated with the invitation. If no association has been, the processing may proceed to step 214. If a validity time was associated with the invitation, the apparatus may determine at 212 based on the validity time whether the invitation is valid. If the invitation is valid, the processing proceeds to step 214. If the invitation is not valid, at step 228 an access is denied for the user.

At step 214 it may be determined whether any visitor identifier was associated with the indication received at step 208. If no visitor identifier was associated, it may be determined at 218 whether a visitor identifier is needed to be obtained. If no visitor identifier is needed at step 218, at step 222 the apparatus may enable at least one access right in the building in response to obtaining the indication of the reading action of the visual token. If the apparatus has direct control over one or more nodes or entities in the building, the apparatus itself may grant access to a node or other entity. In another example embodiment, the apparatus may not have a direct control over the one or more nodes or entities in the building, and the apparatus may send a control request to another controlling entity in the building. For example, an elevator call may have earlier been associated with the visual token reading invitation. When the access right is enabled, the apparatus may automatically transmit a request to an elevator system in the building to allocate an elevator for the elevator call.

If it was determined that a visitor identifier was present at step 214, the received visitor identifier may be compared to the visitor identifier previously associated with the visual token reading invitation at 202. If the comparison provides at step 220 a negative result, an access is denied at step 228. If the comparison provides at step 220 a positive result, the processing proceeds to step 222 in which the apparatus may enable at least one access right in the building.

If at step 218 it was determined that a visitor identifier is needed, at step 224 the apparatus may request a visitor identifier from the visitor. In an example embodiment, a website may be caused to open with a mobile device used by the visitor, and the visitor may be asked to input the visitor identifier via the website. In another example embodiment, the visitor identifier may be input by using an application installed in the mobile device. When the visitor identifier is received at step 226, the processing proceeds back to step 216 for checking the validity of the received visitor identifier.

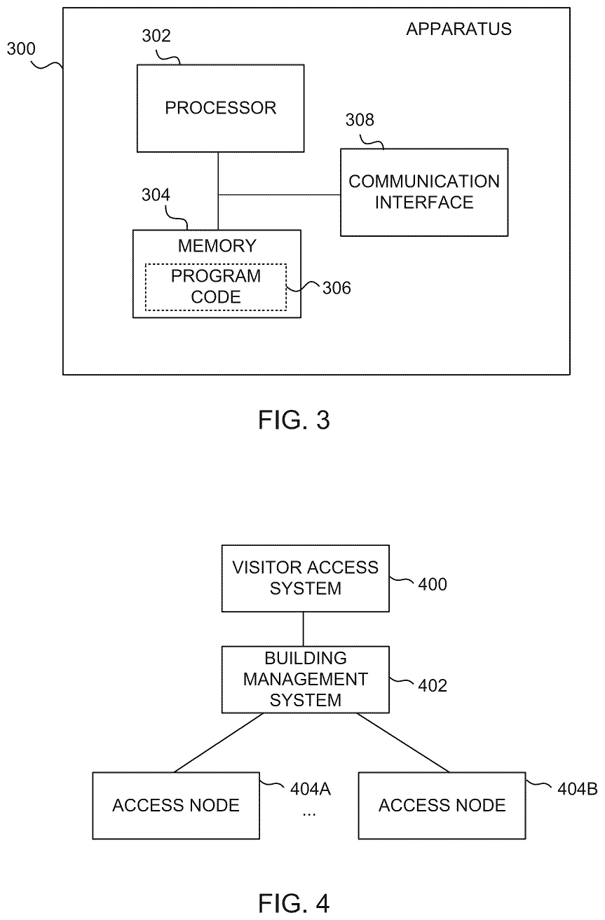

FIG. 3 illustrates an apparatus 300 according to an example embodiment. The apparatus 300 may be, for example, an elevator controller of an elevator system, visitor access apparatus, a building apparatus, or a building management system apparatus. The apparatus 300 may comprise at least one processor 302. The apparatus 300 may further comprise at least one memory 304. The memory 304 may comprise program code 306 which, when executed by the processor 302 causes the apparatus 300 at least one example embodiment. The to perform exemplary embodiments and aspects of the subject-matter can be included within any suitable device, for example, including, servers, workstations, capable of performing the processes of the exemplary embodiments. The exemplary embodiments may also store information relating to various processes described herein. Although the apparatus 300 is illustrated as a single device it is appreciated that, wherever applicable, functions of the apparatus 300 may be distributed to a plurality of devices.

Example embodiments may be implemented in software, hardware, application logic or a combination of software, hardware and application logic. The example embodiments can store information relating to various methods described herein. This information can be stored in one or more memories 304, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

The processor 302 may comprise one or more general purpose processors, microprocessors, digital signal processors, micro-controllers, and the like, programmed according to the teachings of the example embodiments, as will be appreciated by those skilled in the computer and/or software art(s). Appropriate software can be readily prepared by programmers of ordinary skill based on the teachings of the example embodiments, as will be appreciated by those skilled in the software art. In addition, the example embodiments may be implemented by the preparation of application-specific integrated circuits or by interconnecting an appropriate network of conventional component circuits, as will be appreciated by those skilled in the electrical art(s). Thus, the examples are not limited to any specific combination of hardware and/or software. Stored on any one or on a combination of computer readable media, the examples can include software for controlling the components of the example embodiments, for driving the components of the example embodiments, for enabling the components of the example embodiments to interact with a human user, and the like. Such computer readable media further can include a computer program for performing all or a portion (if processing is distributed) of the processing performed in implementing the example embodiments. Computer code devices of the examples may include any suitable interpretable or executable code mechanism, including but not limited to scripts, interpretable programs, dynamic link libraries (DLLs), Java classes and applets, complete executable programs, and the like.

As stated above, the components of the example embodiments may include computer readable medium or memories 304 for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

The apparatus 300 may comprise a communication interface 308 configured to enable the apparatus 300 to transmit and/or receive information, to/from other apparatuses and/or elements associated with an elevator system.

The apparatus 300 may comprise means for performing at least one method discussed herein. In one example, the means may comprise the at least one processor 302, the at least one memory 304 including program code 306 configured to, when executed by the at least one processor 302, cause the apparatus 300 to perform the method discussed hereon.

FIG. 4 illustrates a system comprising a visitor access system 400 connected to a building management system 402. One or more access nodes 404A, 404B may be connected to the building management system 402. In an example embodiment, the visitor access system 400 may comprise the apparatus 300 to implement or more of the embodiments discussed relating to FIG. 1 and FIG. 2. In another example embodiment, the building management system 402 may comprise the visitor access system 400 and thus also the apparatus 300. The access node 404A, 404B may comprise, for example, an access gate, a door or any other access point via which a visitor visiting a building may be required to go through. Thus, in an example embodiment, the at least one access right may comprise opening an access gate, a door or any other access point via which a visitor visiting a building may be required to go through. In an example embodiment, the access node 404A, 404B may comprise a display or a separate display device may be associated with the access node 404A, 404B. The access node 404A, 404B or the display device may be configured to display the visual token discussed earlier. The apparatus 300 may then control the access node 404A, 404B directly or via the building management system 402 to enable or grant access as discussed earlier in FIG. 1 and FIG. 2.

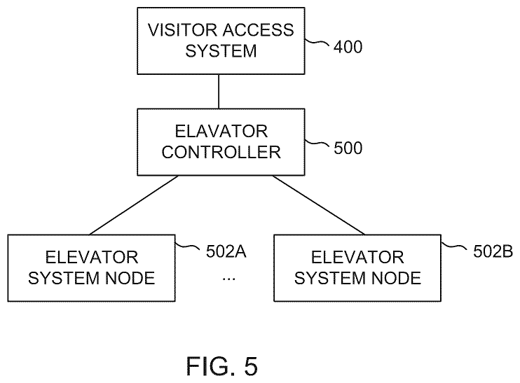

FIG. 5 illustrates a system comprising a visitor access system 400 connected to an elevator controller 500. One or more elevator system nodes 502A, 502B may be connected to the elevator controller 500. In an example embodiment, the visitor access system 400 may comprise the apparatus 300 to implement or more of the embodiments discussed relating to FIG. 1 and FIG. 2. In another example embodiment, the elevator controller 500 may be configured to perform the actions of the apparatus 300 discussed earlier relating to FIG. 1 and FIG. 2. The elevator system node 502A, 502B may comprise, for example, an access gate, a door, a destination operator panel (DOP), a car operator panel (COP) or any other access point via which a visitor visiting a building may be required to go through. The elevator system node 502A, 502B may comprise a display or a separate display device may be associated with the elevator system node 502A, 502B. The elevator system node 502A, 502B or the display device may be configured to display the visual token discussed earlier. The visitor access system 400 may then control the elevator system node 502A, 502B directly or via the elevator controller 500 to enable or grant access as discussed earlier in FIG. 1 and FIG. 2.

In an example embodiment, the at least one access right may comprise an elevator call. In other words, an elevator call to a destination floor has been associated earlier with the visual token reading invitation. When the visitor then opens the visual token reading invitation and reads the visual token, this may cause the previously set elevator call to be allocated.

In an example embodiment of FIG. 4 or FIG. 5, the apparatus 300 in a visitor access system 400 or the building management system 402 or the elevator controller 500 may be configured to cause transmission of an instruction to display guidance information with the access node 404A, 404B or the elevator system node 502A, 502B to reach a predetermined destination in the building in response to enabling the at least one access right. In other words, the guidance information may enable the visitor to reach his/her final destination in the building. The guidance information may comprise, for example, route information and/or an access code to at least one door along the route.

In an example embodiment of FIG. 4 or FIG. 5, the apparatus 300 in a visitor access system 400 or the building management system 402 or the elevator controller 500 may be configured to cause transmission of instruction to display the visual token with the access node 404A, 404B or the elevator system node 502A, 502B in response to obtaining an indication of an opening action of the visual token reading invitation. In other words, in an example embodiment, the visual token may not be visible for the visitor until the visitor opens the invitation he/she has received earlier. This may thus act as a trigger to cause display of the visual token. In another example embodiment, a static visual token, for example, in the form of a sticker, may be arranged close to the access node 404A, 404B or the elevator system node 502A, 502B.

In an example embodiment of FIG. 4 or FIG. 5, the apparatus 300 in a visitor access system 400 or the building management system 402 or the elevator controller 500 may be configured to obtain an indication of at least one additional reading action of the visual token provided at a location of the building, and remove the at least one access right in response to obtaining the indication of at least one additional reading action of the visual token. This may mean, for example, that when a visitor is returning back from his/her destination, the visitor is required at least once to read the visual token again at one or more access points, for example, at a ground floor. This may then be used as an indicator that the visitor has actually left the building after his/her visit.

At least some of the examples and example embodiments may enable a solution for adding security in buildings. Further, as a visitor is able to use his/her own mobile device for reading the visual token, it is possible to implement the visitor access efficiently. Further, at least some of the examples and example embodiments may enable a solution for using already existing devices or displays to display the visual token, for example, a destination operator panel (DOP) or a car operator panel (COP).

While there have been shown and described and pointed out fundamental novel features as applied to preferred embodiments thereof, it will be understood that various omissions and substitutions and changes in the form and details of the devices and methods described may be made by those skilled in the art without departing from the scope of the claims. For example, it is expressly intended that all combinations of those elements and/or method steps which perform substantially the same function in substantially the same way to achieve the same results are within the scope of the claims. Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the claims.

1. A method comprising:
obtaining, by an apparatus, a request to generate a visual token reading invitation for a visitor of a building, the visual token reading invitation being associated with a visual token;
generating, by the apparatus, the visual token reading invitation in response to the request;
obtaining, by the apparatus, an indication of a reading action of the visual token provided at a location of the building; and
enabling, by the apparatus, at least one access right in the building in response to obtaining the indication of the reading action of the visual token.

2. The method of claim 1, further comprising:
associating, by the apparatus, a validity time for the visual token reading invitation;
in response to obtaining the indication of the reading action of the visual token, checking, by the apparatus, the validity of the invitation based on the validity time; and
enabling, by the apparatus, the at least one access right when the invitation is valid.

3. The method of claim 1, further comprising:
associating, by the apparatus, a visitor identifier with the visual token reading invitation.

4. The method of claim 3, further comprising:
obtaining, by the apparatus, a visitor identifier;
comparing, by the apparatus, the obtained visitor identifier with the visitor identifier associated with the visual token reading invitation for; and
enabling, by the apparatus, the at least one access right in the building in response to a positive comparison result.

5. The method of claim 3, further comprising:
in response to obtaining the indication of the reading action of the visual token, causing, by the apparatus, transmission of a request to a node to provide a visitor identifier;
receiving, by the apparatus, the visitor identifier from the node;
comparing, by the apparatus, the received visitor identifier with the visitor identifier associated with the visual token reading invitation; and
enabling, by the apparatus, the at least one access right in response to a successful comparison result.

6. The method of claim 3, wherein the visitor identifier comprises at least one of a phone number, a code, a one-time code, identification information or user registration information associated with an application.

7. The method of claim 1, further comprising:
causing, by the apparatus, transmission of at least one request to an external apparatus to apply the at least one access right.

8. The method of claim 1, further comprising:
associating, by the apparatus, at least one of an elevator call to be made, guidance information or access information with the visual token reading invitation.

9. The method of claim 1, further comprising:
causing, by the apparatus, transmission of the visual token reading invitation.

10. The method of claim 1, wherein the visual token reading invitation is a unique visual token reading invitation.

11. The method of claim 1, wherein the visual token is unique to the visitor.

12. The method of claim 1, further comprising:
causing, by the apparatus, transmission of an instruction to display guidance information with a node to reach a predetermined destination in the building in response to enabling the at least one access right.

13. The method of claim 1, further comprising:
causing, by the apparatus, an instruction to display the visual token with a system node in response to obtaining an indication of an opening action of the visual token reading invitation.

14. The method of claim 1, wherein enabling, by the apparatus, at least one access right in the building in response to obtaining the indication, comprises:
allocating, by the apparatus, an elevator call.

15. The method of claim 1, wherein enabling, by the apparatus, at least one access right in response to obtaining the indication, comprises:
opening, by the apparatus, an access point.

16. The method of claim 1, wherein enabling, by the apparatus, at least one access right in response to obtaining the indication, comprises:
obtaining, by the apparatus, an indication of at least one additional reading action of the visual token provided at a location of the building; and
removing, by the apparatus, the at least one access right in response to obtaining the indication of at least one additional reading action of the visual token.

17. The method of claim 1, wherein the visual token comprises a two-dimensional code, a bar code, a QR code, text, an animation, a number sequence or an alphanumeric sequence.

18. The method of claim 1, wherein the visual token reading invitation comprises

19. The method of claim 1, wherein the apparatus comprises a visitor access system apparatus, an elevator controller or an elevator group controller.

20. An apparatus comprising:
means for obtaining a request to generate a visual token reading invitation for a visitor of a building, the visual token reading invitation being associated with a visual token;
means for generating the visual token reading invitation in response to the request;
means for obtaining an indication of a reading action of the visual token provided at a location of the building; and
means for enabling at least one access right in the building in response to obtaining the indication of the reading action of the visual token.

21. The apparatus of claim 20, further comprising:
means for associating a validity time for the visual token reading invitation;
means for checking the validity of the visual token reading invitation based on the validity time in response to obtaining the indication of the reading action of the visual token; and
means for enabling the at least one access right when the invitation is valid.

22. The apparatus of claim 20, further comprising:
means for associating a visitor identifier with the visual token reading invitation.

23. The apparatus of claim 22, further comprising:
means for obtaining a visitor identifier;
means for comparing the obtained visitor identifier with the visitor identifier associated with the visual token reading invitation for; and
means for enabling the at least one access right in the building in response to a positive comparison result.

24. The apparatus of claim 22, further comprising:
means for causing transmission of a request to a node to provide a visitor identifier in response to obtaining the indication of the reading action of the visual token;
means for receiving the visitor identifier from the node;
means for comparing the received visitor identifier with the visitor identifier associated with the visual token reading invitation; and
means for enabling the at least one access right in response to a successful comparison result.

25. The apparatus of claim 22, wherein the visitor identifier comprises at least one of a phone number, a code, a one-time code, identification information or user registration information associated with an application.

26. The apparatus of claim 20, further comprising:
means for causing transmission of at least one request to an external apparatus to apply the at least one access right.

27. The apparatus of claim 20, further comprising:
means for associating at least one of an elevator call to be made, guidance information or access information with the visual token reading invitation.

28. The apparatus of claim 20, further comprising:
means for causing transmission of the visual token reading invitation.

29. The apparatus of claim 20, wherein the visual token reading invitation is a unique visual token reading invitation.

30. The apparatus of claim 20, wherein the visual token is unique to the visitor.

31. The apparatus of claim 20, further comprising:
means for causing transmission of an instruction to display guidance information with a node to reach a predetermined destination in the building in response to enabling the at least one access right.

32. The apparatus of claim 20, further comprising:
means for causing an instruction to display the visual token with a system node in response to obtaining an indication of an opening action of the visual token reading invitation.

33. The apparatus of claim 20, wherein the means for enabling are configured to allocate an elevator call.

34. The apparatus of claim 20, wherein the means for enabling are configured to open an access point.

35. The apparatus of claim 20, wherein the means for enabling are configured to obtain an indication of at least one additional reading action of the visual token provided at a location of the building, and remove the at least one access right in response to obtaining the indication of at least one additional reading action of the visual token.

36. The apparatus of claim 20, wherein the visual token comprises a two-dimensional code, a bar code, a QR code, text, an animation, a number sequence or an alphanumeric sequence.

37. The apparatus of claim 20, wherein the apparatus comprises an elevator controller or an elevator group controller.

38. A system comprising:
the apparatus of claim 20; and
at least one node configured to display the visual token.

39. The system of claim 38, wherein the system comprises an elevator system comprising at least one elevator.

40. A computer program comprising instructions for causing an apparatus to perform at least the following:
obtaining a request to generate a visual token reading invitation for a visitor of a building, the visual token reading invitation being associated with a visual token; generating the visual token reading invitation in response to the request; obtaining an indication of a reading action of the visual token provided at a location of the building; and enabling at least one access right in the building in response to obtaining the indication of the reading action of the visual token.

41. A non-transitory computer-readable medium comprising a computer program comprising instructions for causing an apparatus to perform at least the following:
obtaining a request to generate a visual token reading invitation for a visitor of a building, the visual token reading invitation being associated with a visual token; generating the visual token reading invitation in response to the request; obtaining an indication of a reading action of the visual token provided at a location of the building; and enabling at least one access right in the building in response to obtaining the indication of the reading action of the visual token.
